(19) United States
(12) Patent Application Publication
(10) Pub. No.: US 2020/0130169 A1
(43) Pub. Date: Apr. 30, 2020

(54) Mechanics Creeper

(71) Applicant: Kevin Michael Bosworth, Sonoma, CA (US)

(72) Inventor: Kevin Michael Bosworth, Sonoma, CA (US)

(21) Appl. No.: 16/170,332

(22) Filed: Oct. 25, 2018

(51) Int. Cl. B25H 5/00; B60B 33/08

(52) U.S. Cl. CPC B25H 5/00; B60B 33/08

(57) ABSTRACT

A mechanics creeper that is strapped to the user using a back pack type harness. The present technology pertains to equipment for a mechanic. Also, the type of wheels used allows it to roll through debris without obstruction. In particular, but not by way of limitation, the present technology provides systems for mechanics to easily do work underneath a vehicle or machine using a mechanics creeper. Furthermore, embodiments of the present technology allow for a mechanics creeper that is easy for a user to transport and store.

### FIELD OF INVENTION

The present technology pertains to equipment for a mechanic. In particular, but not by way of limitation, the present technology provides systems for mechanics to easily do work underneath a vehicle or machine using a mechanics creeper. Furthermore, embodiments of the present technology allow for a mechanics creeper that is easy for a user to transport and store.

### DISCUSSION OF RELATED ART

Though there are many different types of mechanics creepers none are worn like a back pack with straps to affix the device to the user.

U.S. Pat. No. 4,792,147 to Wissing describes a mechanics creeper that can be strapped to the user in certain situations but not wearing the device like a backpack all the time.

U.S. Pat. No. 5,330,209 to Pool discloses a low profile mechanics creeper which includes a closed loop, unitary metal frame supported by heavy duty casters recessed at spaced intervals in the frame. The creeper is thus configured to define a low profile and minimizes user's obstruction by objects for a better field of motion. There are no straps used in any fashion on this device.

The foregoing patents reflect the current state of the art of which the present inventor is aware, Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

### BRIEF DESCRIPTION OF THE DRAWINGS

The accompanying drawings, where like reference numerals and descriptions refer to identical or similar elements throughout the separate views, together with the detailed description below, are incorporated in and form part of the specification, and serve to better illustrate embodiments of concepts that include the claimed disclosure, and explain various principles and advantages of those embodiments.

The methods and systems disclosed herein have been represented, where appropriate, by conventional symbols in the drawings.

### DRAWINGS

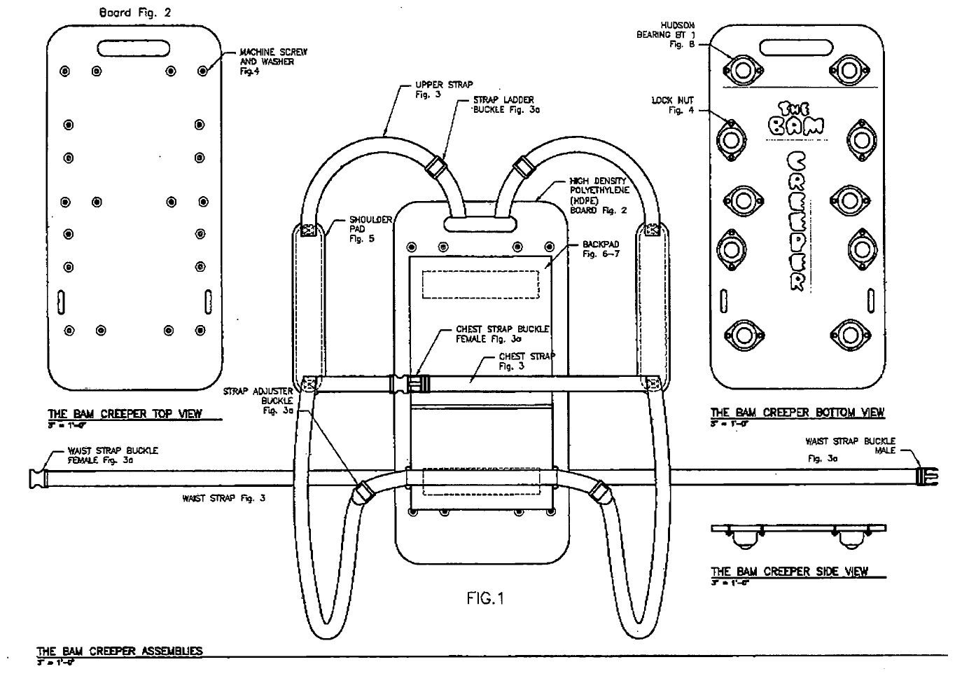

FIG. 1: Overview of complete creeper with straps, wheels and logo

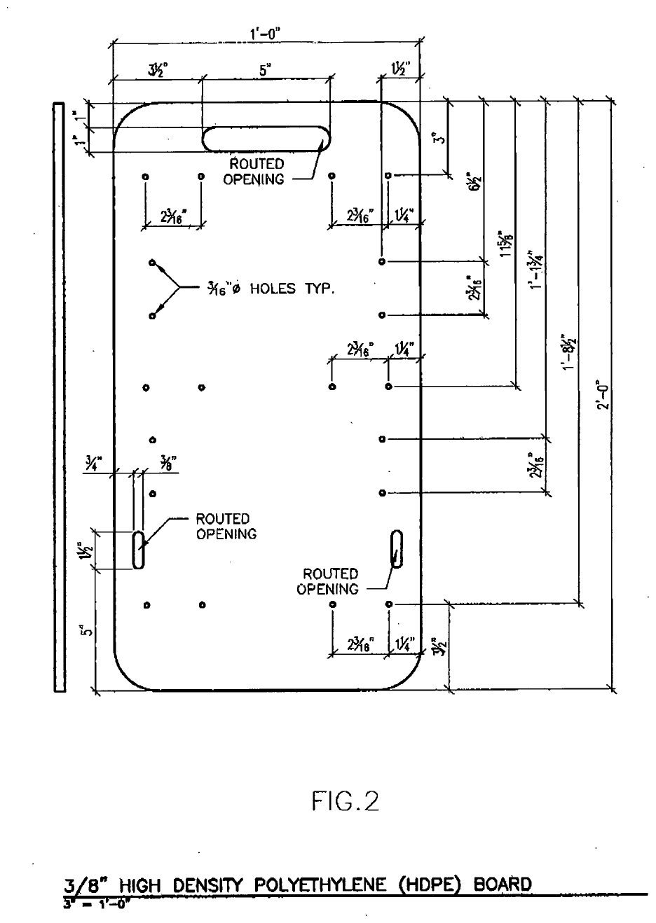

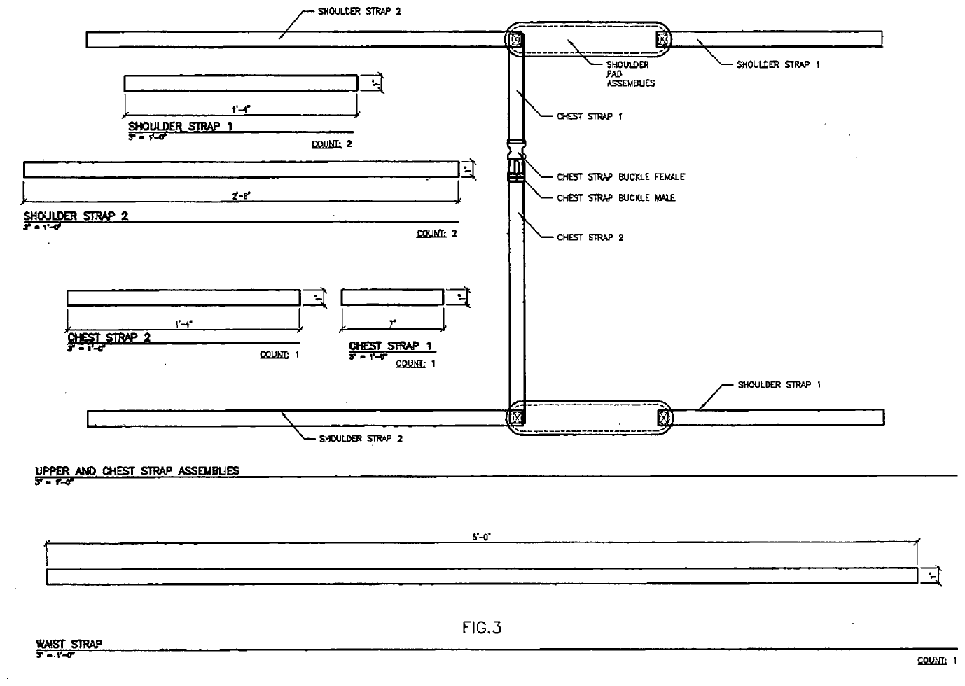

FIG. 2: Detail of board

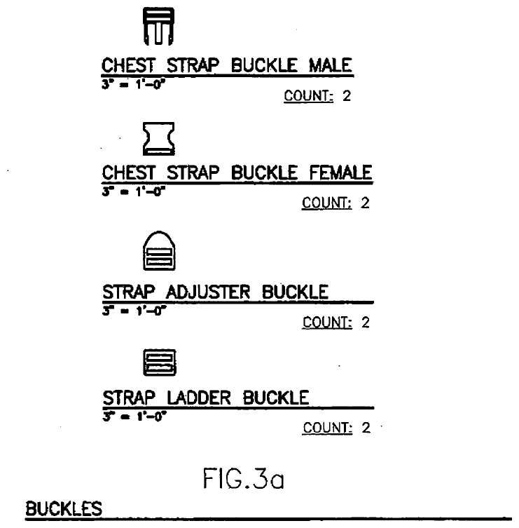

FIG. 3: Detail of straps

FIG. 3A: Description of strap connectors

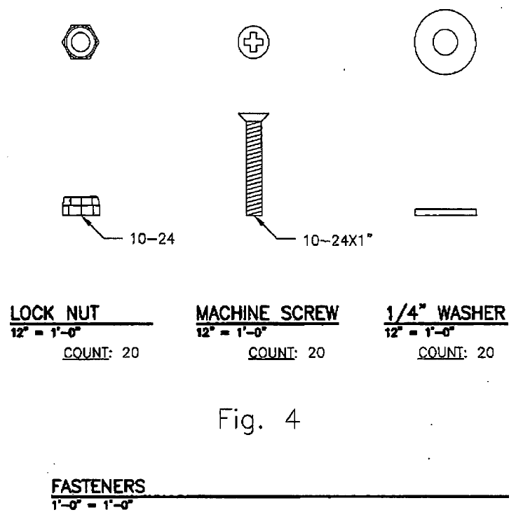

FIG. 4: Description of hardware (nuts, screws and washers)

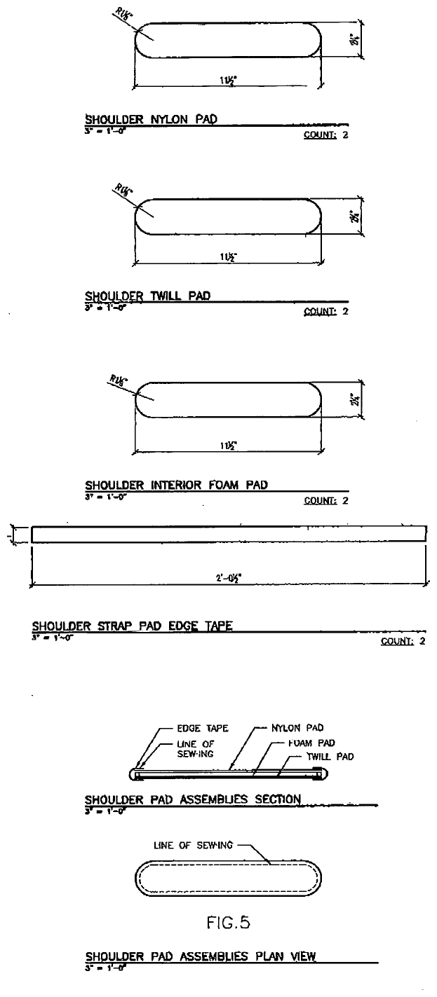

FIG. 5: Detail of shoulder pads

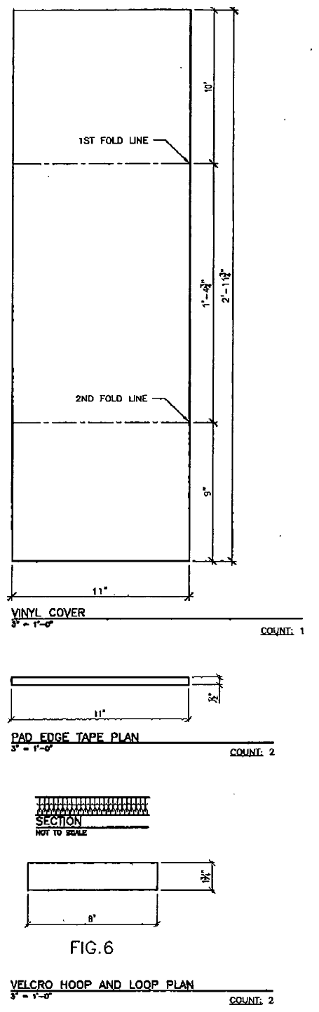

FIG. 6: Detail of back pad

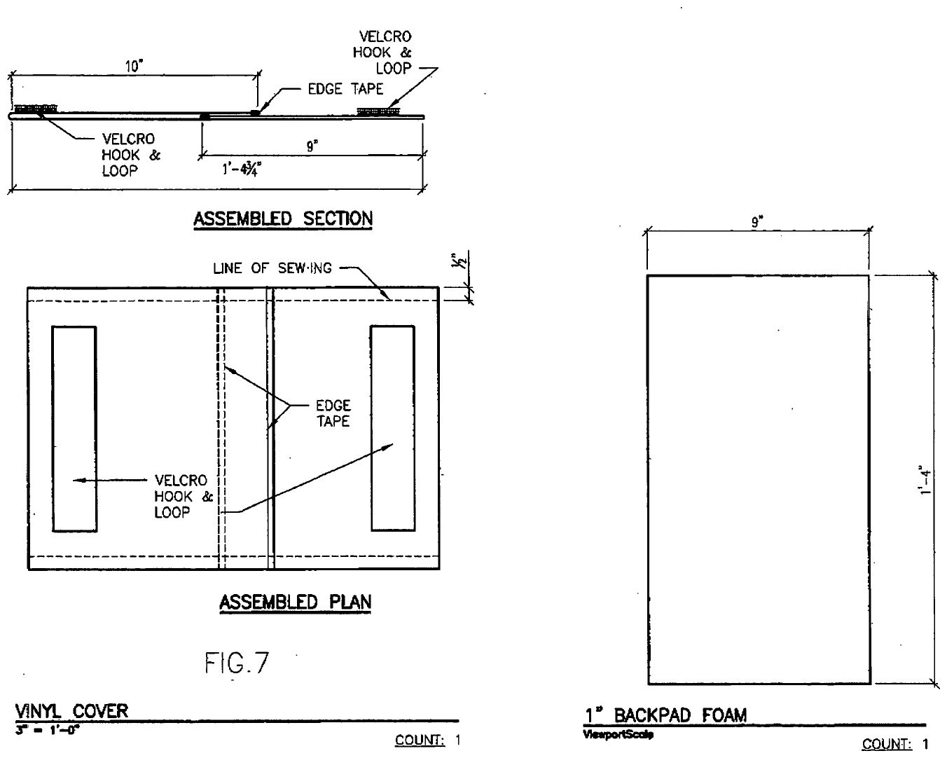

FIG. 7: Detail of back pad, assembled with Velcro

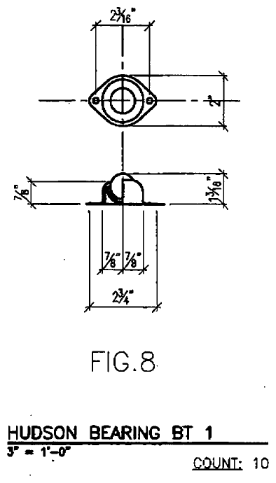

FIG. 8: Detail of wheels

### DETAILED DESCRIPTION

While the present technology is susceptible of embodiment in many different forms, there is shown in the drawings and will be herein described in detail several specific embodiments with the understanding that the present disclosure is to be considered as an exemplification of the principles of the present technology and is not intended to limit the technologyto the embodiments illustrated.

In various embodiments, the present technology provides a mechanics creeper. In various embodiments, the mechanics creeper can be used by a vehicle mechanic to easily access underneath a vehicle. Furthermore the mechanics creeper includes ease of use features such as, unhindered movement while using, allows a user to easily transport and store the mechanics creeper.

In some embodiments, the design of present technology incorporates several ease of use features. For example, the mechanics creeper may be worn over the shoulders using incorporated straps that also have a chest strap attached for additional security while being worn. In some instances, the user may wear the mechanics creeper over one shoulder. In various instances, the use may wear the mechanics creeper over both shoulders. In some instances, the chest strap helps to stabilize the mechanics creeper while being used. In various embodiments, the present technology is designed to stay with the user, thus, creating a safer work environment. For example, the mechanics creeper may not be left lying on the ground when not in use, through the ease of use features. Thus no one will trip and fall over the mechanics creeper creating a safer working environment.

In some embodiments, the mechanics creeper can be used for access under vehicles or machines that have the necessary ground clearance. The mechanics creeper has a low profile to allow for use under many different types of machines and equipment. For example, the mechanics creeper allows for easy access under cars, trucks, boats, heavy equipment or any other type of machine or equipment that has the necessary ground clearance.

In various embodiments, the present technology can be used as a dolly. In some instances, when being used as a dolly, the mechanics creeper can transport up to 750 pounds. For example, the backpack straps and back-pad may be removed from the mechanics creeper for easier use as a dolly.

In various embodiments, the present technology allows the mechanics creeper to operate on any solid surface. For example, the mechanics creeper can roll on a concrete floor with expansion joints, asphalt, or even on firmly pack dirt. For example, use of multi wheels with rounded contact points allows for non-stick operation and multi-directional capabilities, in some instances, the mechanics creeper includes wheels in an alternating-axis-ten-wheel configuration for optimal maneuverability and stability.

### DETAILED DESCRIPTION OF THE ILLUSTRATED EMBODIMENT

The Process of Making the Backboard

(All Descriptions are Explained Using the “Top” Edge, being Width and “Side” Description being Length, FIG. 2, “Wheels” Refer to the Bearings FIG. 8)

They are cut to size and shaped by cutting the corners in a 90 degree arc (see FIG. 2). Cut a hand slot parallel with top edge of board Cut two smaller slots on lower part of board for straps (FIG. 2). Next drill holes, two rows for attaching “wheels”, holes start with two holes parallel to top edge of board and then alternate axis on holes sets with second set parallel to side edge of board and so on (see FIG. 2). Next step is sanding all edges including slots so there are no sharp edges.

Final step is to silkscreen the logo (Bottom view FIG. 1) and attach Velcro for back pad (see vinyl cover view FIG. 7).

The Process of Making the Shoulder Straps

The pads are cut from nylon and twill material with a foam piece between and sewn with a twill material as edging (shoulder pad assemblies view, FIG. 5), The straps are cut from a nylon strapping material and the ends are melted with a torch lighter to prevent fraying (upper and chest strap assemblies view FIG. 3). The upper shoulder straps are sewn onto the pad so they are firmly affixed to the pad. The bottom straps are sewn to the pad in the same manner as the upper strap (upper and chest strap assemblies view FIG. 3). The upper shoulder strap goes through a ladder clip (upper and chest strap assemblies view FIG. 3a) so it can be attached through the top slot on board (see the BAM creeper assemblies view FIG. 1). The left chest strap is sewn onto the pad and then the right side of the chest strap is sewn onto the pad (upper and chest strap assemblies view FIG. 3). A Strap Adjuster Buckle Ladder Tension Lock Clip (see the upper and chest strap assemblies view FIG. 3a) is used to attach the lower strap through the side slots on board (see the BAM creeper assemblies view FIG. 1). The left chest strap is inserted through the top part of the female side of the buckle and folded over and sewn closed (upper and chest strap assemblies view FIG. 3). The right chest strap is then threaded through the male buckle (see the BAM creeper assemblies view FIG. 1 and the upper and chest strap assemblies view FIG. 3a). For the waist strap, one end of the waist strap is inserted through the top part of the female side of the buckle and sewn closed (upper and chest strap assemblies view FIG. 3). The strap is then threaded through the male part of the buckle (see the upper and chest strap assemblies view FIG. 3).

The Process for Making the Pillow (Back Pad)

(See the “Vinyl Cover and Pad Views FIG. 6-7” for the Below Descriptive Process)

The pillow is made from Vinyl and there is an inner piece made from foam. A piece of edging tape is sewn to each end of the material (FIG. 6). It is then folded with the outside surface facing each other and opening in the middle and sewn to create an envelope. Then it is turned right side out. The foam piece is then inserted into the opening. Velcro is attached to the pad at the top and bottom back of pillow and is used to secure pad to board (FIG. 7).

I claim:

1. A mechanics creeper that is strapped to the user using a back pack type harness, uses bearings instead of wheels which allows it to roll through debris with limited obstruction and is easy for a user to transport and store.
